(19) United States
(12) Patent Application Publication
(10) Pub. No.: US 2011/0279402 A1
(43) Pub. Date: Nov. 17, 2011

(54) TOUCH SCREEN

(75) Inventors: Dong Sik Yoo, Seoul (KR); Yun Ki Hong, Gyunggi-do (KR); Hee Bum Lee, Gyunggi-do (KR); Kyoung Soo Chae, Gyunggi-do (KR); Yong Soo Oh, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/877,917

(22) Filed: Sep. 8, 2010

(30) Foreign Application Priority Data
May 14, 2010 (KR) 10-2010-0045431

(51) Int. Cl. G06F 3/045

(52) U.S. Cl. 345/174

(57) ABSTRACT

Disclosed herein is a touch screen. The touch screen includes a transparent electrode that is formed on one surface of a first transparent substrate to sense change in capacitance at the time of a touch input; an electrode that is formed on a second transparent substrate formed on the other surface of the first transparent substrate to apply voltage to the transparent electrode; and a via that penetrates through the first transparent substrate to electrically connect the transparent electrode to the electrode. The transparent electrode and the electrode are formed on the transparent substrates at different layers, thereby reducing an inactive region.

### CROSS REFERENCE TO RELATED APPLICATION

This application claims the benefit of Korean Patent Application No. 10-2010-0045431, filed on May 14, 2010, entitled “Touch Screen”, which is hereby incorporated by reference in its entirety into this application.

### BACKGROUND OF THE INVENTION

1. Technical Field

The present invention relates to a touch screen.

2. Description of the Related Art

With the continuous development in the electronic technology and the information technology fields, the relative importance of electronic devices is constantly increasing in everyday life, including a work environment. In particular, as electronic technology continuously develops, touch screens are used in portable devices that are recently reduced in size and thickness.

Touch screens, devices generally installed in display devices to detect positions on the screen touched by a user and control electronic devices, using information on the detected touched position as input information, in addition to controlling the screen of the display, have various advantages of being simply operated with little malfunction in a small space and very compatible with IT devices.

Meanwhile, the touch screen is classifiable as a resistive type, a capacitive type, an electromagnetic type, a surface acoustic wave (SAW) type, an infrared type, and so on. Among others, resistive and capacitive types are prevalently used in consideration of the functions and economic. In recent, more research on the capacitive type touch screen having excellent touch sense and durability, and capable of multi touch have been conducted.

FIG. 1 is a cross-sectional view of a capacitive touch screen 10 according to the prior art, and FIG. 2 is an exploded perspective view of the touch screen 10 of FIG. 1. Hereinafter, the capacitive touch screen 10 according to the prior art will be described with reference to the figures.

As shown in FIGS. 1 and 2, the capacitive touch screen 10 according to the prior art includes a transparent substrate 11, an indium tin oxide (ITO) electrode 12, an electrode 13, and a window plate 14.

Herein, the ITO electrode 120 is formed on one surface of the transparent substrate 11, and the electrode 13 that applies voltage to the ITO electrode 12 is formed outside the transparent substrate 11, that is, in an inactive region B. Further, the window plate 14 to which a user applies a touch input is bonded to one surface of the transparent substrate 11 on which the ITO electrode 12 is formed by an adhesive layer 15. Meanwhile, the ITO electrode 12 includes one layer in which X-axis patterns 16 and Y-axis patterns 17 are formed. At this time, the Y-axis patterns 17 are connected through a Y-axis connection unit 19 and the X-axis patterns 16 are connected through an X-axis connection unit 18, wherein an insulating pattern 20 is formed between the Y-axis connection unit 19 and the X-axis connection unit 18 to prevent a short-circuit between the X-axis patterns 16 and the Y-axis patterns 17.

Meanwhile, when a user applies a touch input, the ITO electrode 12 becomes an electrode and the window plate 14 becomes dielectrics to generate parasitic capacitance, such that the change in capacitance due to the generated parasitic capacitance is sensed, thereby making it possible to detect the position of the touch input.

However, in the capacitive touch screen 10 according to the prior art, the electrode 13 is formed outside the transparent substrate 11 so that the ITO electrode 12 cannot be formed outside the transparent substrate 11. As a result, there is a problem in that the inactive region B is formed outside the touch screen 10. Therefore, when a user applies a touch input to the outside of the touch screen 10, the touch screen 10 is not normally operated.

### SUMMARY OF THE INVENTION

The present invention has been made in an effort to provide a touch screen that reduces an inactive region by changing dispositions of the electrodes formed outside a transparent substrate.

A touch screen according to a first preferred embodiment of the present invention includes: a transparent electrode that is formed on one surface of a first transparent substrate to sense change in capacitance at the time of touch input; an electrode that is formed on a second transparent substrate formed on the other surface of the first transparent substrate to apply voltage to the transparent electrode; and a via that penetrates through the first transparent substrate to electrically connect the transparent electrode to the electrode.

Herein, the transparent electrode, the electrode, and the via are made of a conductive polymer.

Further, the transparent electrode, the electrode, and the via are made of poly-3, 4-ethylenedioxythiophene/polystyrenesulfonate (PEDOT/PSS).

Further, the touch screen further includes a window plate that is formed on one surface of the first transparent substrate on which the transparent electrode is formed.

A touch screen according to a second preferred embodiment of the present invention includes: two sheets of first transparent substrates that are formed to be opposite to each other; transparent electrodes each that are formed on one of the surfaces of the two sheets of first transparent substrates to sense signals at the time of a touch input; second transparent substrates each that are formed on the other surfaces of the two sheets of first transparent substrates; electrodes each that are formed on the second transparent substrates to apply voltage to the transparent electrodes; and vias that penetrate through the first transparent substrates to electrically connect the transparent electrodes to the electrodes.

Herein, the touch screen further includes an adhesive layer that is formed between the two sheets of transparent substrates on which the transparent electrodes are formed, wherein the transparent electrodes sense the change in capacitance at the time of the touch input.

The touch screen further includes: an adhesive layer that is formed at the outside between the two sheets of transparent substrates on which the transparent electrodes are formed; and a dot spacer that is formed on the transparent electrode formed on any one of the two sheets of transparent substrates, wherein the transparent electrodes formed on the two sheets of transparent substrates contact each other at the time of the touch input to sense change in resistance or voltage.

Further, the transparent electrode, the electrode, and the via are made of a conductive polymer.

Further, the transparent electrode, the electrode, and the via are made of poly-3, 4-ethylenedioxythiophene/polystyrenesulfonate (PEDOT/PSS).

### BRIEF DESCRIPTION OF THE DRAWINGS

FIG. 1 is a cross-sectional view of a capacitive touch screen according to the prior art;

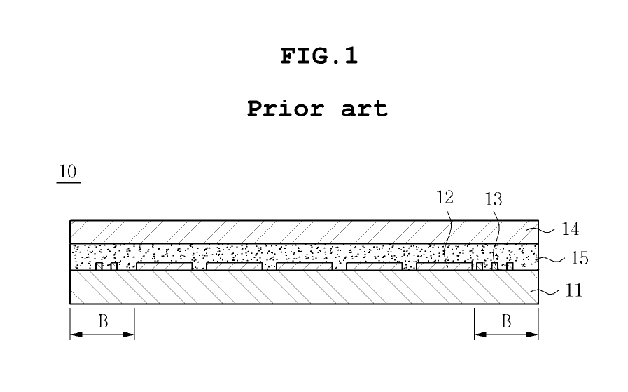

FIG. 2 is an exploded perspective view of the touch screen of FIG. 1;

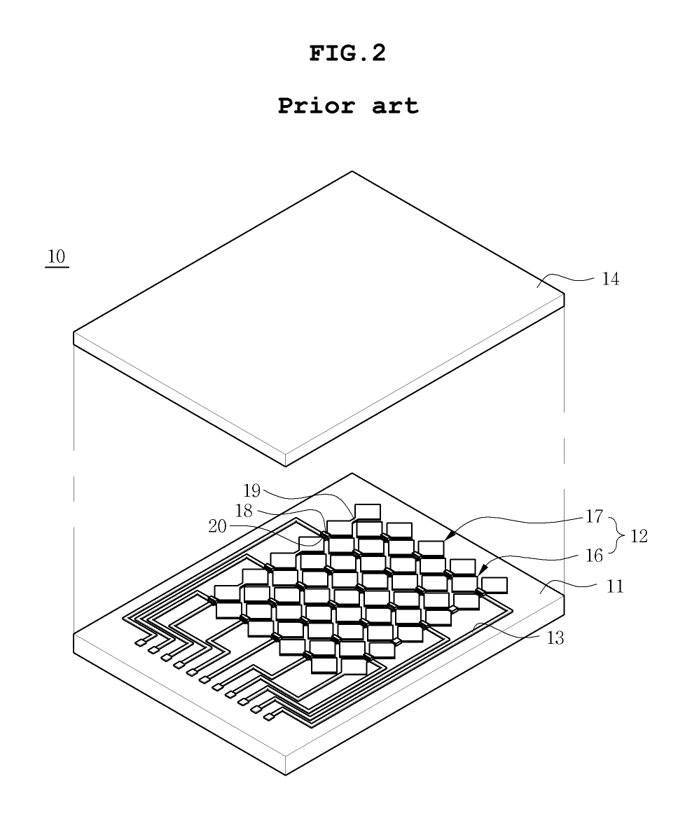

FIG. 3 is a cross-sectional view of a touch screen according to a first preferred embodiment of the present invention;

FIG. 4 is an exploded perspective view of the touch screen of FIG. 3; and

FIG. 5 is a cross-sectional view of a touch screen according to a second preferred embodiment of the present invention.

### DESCRIPTION OF THE PREFERRED EMBODIMENTS

Various features and advantages of the invention will become apparent from the following description of the embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Meanwhile, in the use of terms in the present invention, “touch input” means both “touch” and “proximity”. “Touch” means of being in completely touched, and “proximity” means being very close even but not being completely touched.

Hereinafter, preferred embodiments of the present invention will be described in detail with reference to the accompanying drawings.

Structure of Touch Screen—First Embodiment

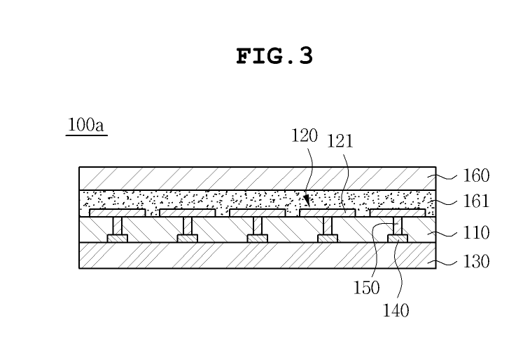

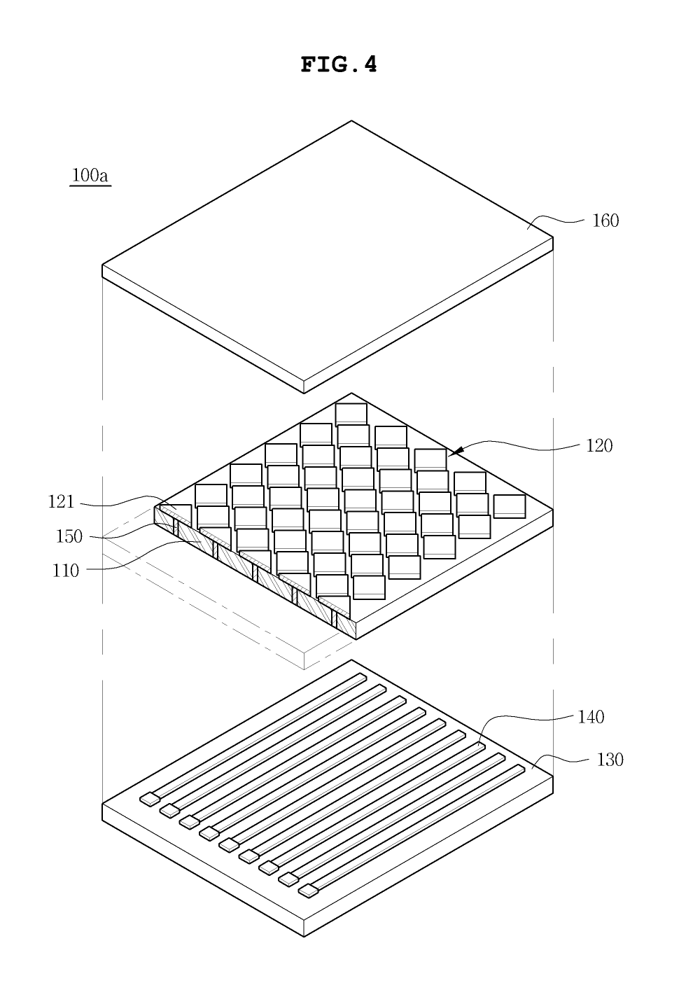

FIG. 3 is a cross-sectional view of a touch screen 100a according to a first preferred embodiment of the present invention, and FIG. 4 is an exploded perspective view of the touch screen 100a of FIG. 3. Hereinafter, the touch screen 100a according to the present embodiment will be described with reference to the figures. In the present embodiment, the capacitive touch screen 100a having a transparent electrode 120 formed of one layer will be described.

As shown in FIGS. 3 and 4, the touch screen 100a according to the present embodiment includes a first transparent substrate 110, a transparent electrode 120, a second transparent substrate 130, an electrode 140, a via 150, and a window plate 160.

The first transparent substrate 110 is a member that provides a space where the transparent electrode 120 and the via 150 are formed.

Herein, it is preferable that the first transparent substrate 110 is made of a transparent material so that an image from a display (not shown) installed at the lower portion of the touch screen 100a can be clearly transferred to a user. The first transparent substrate 110 may, for example, be made of polyethyleneterephthalate (PET), polycarbonate (PC), polymethylmetacrylate (PMMA), polyethylenenaphthalenedicarboxylate (PEN), polyethersulfone (PES) or cyclic olefin copolymer (COC). Besides, glass or tempered glass that is generally used may also be used.

Further, the transparent electrode 120 is formed on one surface of the first transparent substrate 110, such that it is preferable to apply high-frequency treatment or primer treatment thereto in order to improve the adhesion with the transparent electrode 120.

The transparent electrode 120 is a member that is formed on one surface of the transparent substrate 110 to sense the change in capacitance at the time of touch input.

Herein, the transparent electrode 120 senses the change in capacitance from the touch input of a specific object, such as a user's body or a stylus pen, etc. and transmits the changes to a controller (not shown), and then the controller (not shown) recognizes the coordinates of the pressed position, thereby implementing desired operations. More specifically, when high frequency is diffused throughout the transparent electrodes 120 by applying voltage through the electrodes 140 and then the touch input is applied by a human body etc., a predetermined change occurs in capacitance while the transparent electrodes 120 function as electrodes and the window plate 160 functions as dielectrics, and the controller (not shown) can recognize the touch position or whether there is contact, etc., by detecting the changed waveform.

Meanwhile, it is preferable that the transparent electrode 120 is made of a conductive material so as to sense the change in capacitance. Further, it is preferable that the transparent electrode 120 is made of a transparent material, since it is formed over the first transparent substrate 110. The transparent electrodes 120 may, for example, be made of conductive polymer containing poly-3,4-ethylenedioxythiophene/polystyrenesulfonate (PEDOT/PSS), polyaniline alone or a mixture thereof, or metal oxides, such as indium tin oxide (ITO). At this time, when the transparent electrode 120 is made of a conductive polymer, it may be formed on the first transparent substrate 110 by a silk screen printing method, an inkjet printing method, a gravure printing method, or an offset printing method.

In addition, a plurality of sensing units 121 formed on the transparent electrode 120 to be spaced from each other may be separately connected to the electrode 140 through the via 150. Therefore, each sensing unit 121 may be in a state electrically isolated. The present invention is not limited thereto, however, the plurality of sensing units 121 may be divided into the X-axis patterns and the Y-axis patterns to be connected on the first transparent substrate 110 and may be connected to only the electrode 140 to be connected to a FPC (not shown) through the via 150. Meanwhile, although the sensing unit 121 is shown to have a diamond shape in FIG. 4, it is shown by way of example only but may have various shapes, such as a rod shape, a hexagonal shape, an octagonal shape, and a triangular shape, or the like.

The second transparent substrate 130 is a member that is formed on the other surface of the first transparent substrate 110 to provide a space where the electrode 140 is formed.

Herein, it is preferable that the second transparent substrate 130 is made of a transparent material, for example, polyethylene terephthalate (PET), similar to the first transparent substrate 110. Meanwhile, since the electrode 140 is formed between the first transparent substrate 110 and the second transparent substrate 130, any one of the first transparent substrate 110 and the second transparent substrate 130 is formed of a flexible member, such that the electrode 140 may be impregnated. FIG. 3 shows the case where the first transparent substrate 110 is formed of a flexible member so that the electrode 140 is impregnated into the first transparent substrate 110, but the present invention is not limited thereto.

The electrode 140 is a member that is formed on the second transparent substrate 130 to be connected to the transparent electrode 120 through the via 150.

Herein, the electrode 140 may apply voltage to the transparent electrode 120 so that the transparent electrode 120 can sense the change in capacitance. Therefore, it is preferable that the electrode 140 is formed of a conductive member. In addition, the electrode 140 is formed over the second transparent substrate 130 rather than the outside of the second transparent substrate 130, such that it is preferable that the electrode 140 is made of a transparent material so that a user can clearly see an image from a display (not shown). Therefore, the electrode 140 may, for example, be made of a conductive polymer such as poly-3, 4-ethylenedioxythiophene/polystyrenesulfonate (PEDOT/PSS), similar to the transparent electrode 120.

Meanwhile, the electrode 140 is formed on a different layer from the transparent electrode 120, that is, the transparent electrode 120 is formed on the first transparent substrate 110 and the electrode 140 is formed on the second transparent substrate 130, such that the transparent electrode 120 may be expanded to the outside of the first transparent substrate 110. Therefore, although a user applies a touch input to the outside of the touch screen 100a, the transparent electrode 120 is also formed outside, thereby making it possible to detect the position of the touch input.

Meanwhile, although FIG. 4 shows the case where the electrodes 140 are shown as a combination of straights in one direction and thus the sensing units 121 on the same line are connected to the same electrode 140, it is shown by way of example only but the electrodes 140 corresponding to each sensing unit 121 may also be separate, respectively.

The via 150 is a member that penetrates through the first transparent substrate 110 to electrically connect the transparent electrode 120 to the electrode 140.

Herein, the via 150 electrically connects the electrode 140 that applies voltage to the transparent electrode 120 to the transparent electrode 120. The transparent electrode 120 is formed on one surface of the first transparent substrate 110 and the electrode 140 is formed between the second transparent substrate 130 and the first transparent substrate 110, that is, in the direction of the other surface of the first transparent substrate 110, such that the via 150 may penetrate through the first transparent substrate 110 in order to connect the transparent electrode 120 to the electrode 140.

Meanwhile, the via 150 is formed over the first transparent substrate 110, such that it may be made of a conductive polymer, such as poly-3, 4-ethylenedioxythiophene/polystyrenesulfonate (PEDOT/PSS), being conductive and transparent. At this time, when both the via 150 and the transparent electrode 120 are made of a conductive polymer, they may be formed on the first transparent substrate 110, for example, by a silk screen printing method, an inkjet printing method, a gravure printing method, or an offset printing method.

For example, a method for forming the via 150 and the transparent electrode 120 by a silk screen printing method will be described. First, a via hole (not shown) is formed at a position where a via 150 is formed, for example, by a laser method. Next, an ink paste made of a conductive polymer is put on a screen in a state in which the screen is tightly pulled by strong tension and then the paste is pushed out to the surface of the first substrate 110 through the mesh of a screen so as to be transferred by pushing down and moving a squeegee. At this time, the via hole (not shown) is filled with the paste, such that the via 150 and the transparent electrode 120 can be simultaneously formed. When the via 150 and the transparent electrode 120 are simultaneously formed, the processing costs and processing time of the touch screen 100a can be reduced.

The window plate 160 is a member that is formed on one surface of the first transparent substrate 110 on which the transparent electrode 120 is formed to protect other components of the touch screen 100a.

Herein, the window plate 160, which is a part receiving an input from a specific object, such as a user's body or a stylus pen, maintains the external appearance of an input unit of the touch screen 100a. Therefore, it is preferable that the window plate 160 is made of a transparent material, for example, polyethylene terephthalate (PET) or glass, which enables a user to see a display well and has large durability so as to sufficiently protect the touch screen 100a from the external force.

Meanwhile, an adhesive layer 161 may be formed between the window plate 160 and the first transparent substrate 110 so as to fix the window plate 160 and the first transparent substrate 110. At this time, the adhesive layer 161 is formed on the entire surface between the window plate 160 and the first transparent substrate 110. The adhesive layer 161 may be formed of, for example, an optical clear adhesive (OCA).

Structure of Touch Screen—Second Embodiment

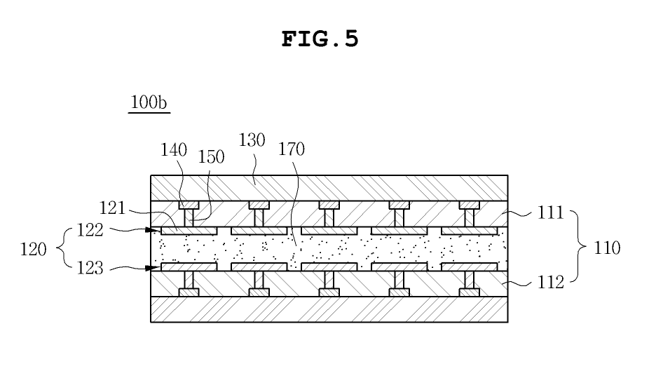

FIG. 5 is a cross-sectional view of a touch screen 100b according to a second preferred embodiment of the present invention. Hereinafter, the touch screen 100b according to the present embodiment will be described with reference to the figure. Although a capacitive touch screen including a transparent electrode 120 formed of two layers will be described in the present embodiment, the present invention is not limited thereto but may also include a resistive touch screen including a transparent electrode formed of two layers. Herein, like reference numerals will designate like or corresponding components and the description overlapping with the first embodiment will be omitted.

As shown in FIG. 5, the touch screen 100b according to the present embodiment includes two sheets of first transparent substrates 110, transparent electrodes 120, second transparent substrates 130, electrodes 140, vias 150, and an adhesive layer 170.

The first transparent substrate 110 may be formed of a first upper transparent substrate 111 and a first lower transparent substrate 112, wherein the first upper transparent substrate 111 and the first lower transparent substrate 112 may be opposite to each other and spaced from each other.

The transparent electrodes 120 each are formed on the two sheets of first transparent substrates 110 and are formed in X-axis patterns and Y-axis patterns to sense the change in capacitance.

Herein, the transparent electrode 120 is formed of an upper transparent electrode 122 formed on the first upper transparent substrate 111 and a lower transparent electrode 123 formed on the first lower transparent substrate 112, wherein the upper transparent electrode 122 may be formed to be opposite to the lower transparent electrode 123.

The adhesive layer 170 is formed between the first upper transparent substrate 111 and the first lower transparent substrate 112 to bond the first upper transparent substrate 111 to the first lower transparent substrate 112.

Herein, the adhesive layer 170 may be formed on the entire surface between the first upper transparent substrate 111 and the first lower transparent substrate 112 and serve to electrically insulate the upper transparent electrode 122 from the lower transparent electrode 123. In addition, since the adhesive layer 170 is formed on the entire surface between the first transparent substrates 110, it should be transparent so that a user can see a display. To this end, the adhesive layer 170 may be formed of an optical clear adhesive (OCA).

Meanwhile, although the present embodiment describes the case of the capacitive touch screen, in the case of a resistive touch screen, the adhesive layer (not shown) may be formed at the outside between the first upper transparent substrate 111 and the first lower transparent substrate 112, and a dot spacer may be formed on any one of the upper transparent electrode 122 and the lower transparent electrode 123 inside the adhesive layer (not shown). Further, the upper transparent electrode 122 and the lower transparent electrode 123 contact each other at the time of a touch input, thereby making it possible to sense change in resistance or voltage.

With the touch screen according to the present invention, the transparent electrode is formed on the first transparent substrate, the electrode is formed on the second transparent substrate, and the transparent electrode is connected to the electrode through the via, thereby reducing the inactive region.

In addition, according to the present invention, the transparent electrode, the electrode, the via are made of a conductive polymer, such that transparency is ensured and a process thereof is simplified, thereby making it possible to reduce processing costs and processing time.

Although the preferred embodiments of the present invention have been disclosed for illustrative purposes, they are for specifically explaining the present invention and thus the touch screen according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch screen, comprising:
a transparent electrode that is formed on one surface of a first transparent substrate to sense change in capacitance at the time of a touch input;
an electrode that is formed on a second transparent substrate formed on the other surface of the first transparent substrate to apply voltage to the transparent electrode; and
a via that penetrates through the first transparent substrate to electrically connect the transparent electrode to the electrode.

2. The touch screen as set forth in claim 1, wherein the transparent electrode, the electrode, and the via are made of a conductive polymer.

3. The touch screen as set forth in claim 1, wherein the transparent electrode, the electrode, and the via are made of poly-3, 4-ethylenedioxythiophene/polystyrenesulfonate (PEDOT/PSS).

4. The touch screen as set forth in claim 1, further comprising:
a window plate that is formed on one surface of the first transparent substrate on which the transparent electrode is formed.

5. A touch screen, comprising:
two sheets of first transparent substrates that are formed to be opposite to each other;
transparent electrodes each that are formed on one of the surfaces of the two sheets of first transparent substrates to sense signals at the time of a touch input;
second transparent substrates each that are formed on the other surfaces of the two sheets of first transparent substrates;
electrodes each that are formed on the second transparent substrates to apply voltage to the transparent electrodes; and
vias that penetrate through the first transparent substrates to electrically connect the transparent electrodes to the electrodes.

6. The touch screen as set forth in claim 5, further comprising:
an adhesive layer that is formed between the two sheets of transparent substrates on which the transparent electrodes are formed,
wherein the transparent electrodes sense the change in capacitance at the time of the touch input.

7. The touch screen as set forth in claim 5, further comprising:
an adhesive layer that is formed at the outside between the two sheets of transparent substrates on which the transparent electrodes are formed; and
a dot spacer that is formed on the transparent electrode formed on any one of the two sheets of transparent substrates,
wherein the transparent electrodes formed on the two sheets of transparent substrates contact each other at the time of the touch input to sense change in resistance or voltage.

8. The touch screen as set forth in claim 5, wherein the transparent electrode, the electrode, and the via are made of a conductive polymer.

9. The touch screen as set forth in claim 5, wherein the transparent electrode, the electrode, and the via are made of poly-3, 4-ethylenedioxythiophene/polystyrenesulfonate(PEDOT/PSS).
